(19) United States
(12) Patent Application Publication
(10) Pub. No.: US 2013/0047800 A1
(43) Pub. Date: Feb. 28, 2013

(54) Hand tool

(71) Applicant: Cheng-Hui Wang, New Taipei City (TW)

(72) Inventor: Cheng-Hui Wang, New Taipei City (TW)

(73) Assignee: EZCONN CORPORATION, Taipei City (TW)

(21) Appl. No.: 13/137,644

(22) Filed: Aug. 31, 2011

(51) Int. Cl. B25B 23/159

(52) U.S. Cl. 81/477

(57) ABSTRACT

A hand tool includes a tool shaft having a shank and a handle pivotally coupled together, and a tool head, which includes a socket defining a socket hole attachable to a locknut at a coaxial cable for fastening or loosening the locknut and a side opening for the passing of the locknut into or out of the socket hole, a driven structure located on an inner side of a receiving hole at one side of the socket hole, a transmission shaft coupled to the shank of the tool shaft and having a driving head located on one end thereof for engagement with the driven structure of the socket, and an elastic member stopped between the driving head and the socket such that when the socket reaches a predetermined torque value during operation, the driving head is moved axially away from the driven structure to compress the elastic member and to run idle.

### BACKGROUND OF THE INVENTION

1. Field of the Invention

The present invention relates to hand tools and more particularly, to a hand tool for fastening a locknut of a coaxial cable to a connection screw rod of an electrical connector at an electronic device of a cable TV system, which automatically runs idle when the socket thereof reaches a predetermined torque value during operation, avoiding damage.

2. Description of the Related Art

CATV (Community antenna television or community access television) is known as cable TV that brings television programs to people throughout the world who are connected to a community antenna. Cable television provides television programs to consumers via radio frequency signals transmitted to televisions through coaxial cables or digital light pulses through fixed optical fibers located on the subscriber's property. In addition to bringing television programs to consumers, cable TV is a good way to interact with the World Wide Web and other new forms of multimedia information and entertainment services.

Further, when connecting a coaxial cable to a signal distributor, a locknut is used to lock the signal connector at the end of the coaxial cable to a mating electrical connector at the signal distributor. During installation, a wrench is needed to fasten tight the locknut. FIG. 9 illustrates a conventional wrench for this purpose. As illustrated, the wrench comprises a link A, and two sockets B respectively arranged at the two distal ends of the link A at right angles. Each socket B defines a socket hole B1 and a side opening B11. As the two sockets B are arranged at right angles, they can be selectively used for fastening/unfastening a locknut at different angles. However, when the user bias the link A to rotate one socket B in fastening the locknut to the mating electrical connector at the signal distributor, an excessive high pressure may be applied, causing locknut or socket damage. When the locknut or the socket starts to wear, the user may be unable to rotate the locknut positively. Thus, this design of wrench is not durable in use.

### SUMMARY OF THE INVENTION

The present invention has been accomplished under the circumstances in view. It is the main object of the present invention to provide a hand tool, which is practical for fastening a locknut of a coaxial cable to a matching electrical connector at a signal distributor of a cable TV and will automatically run idle when the socket thereof reaches a predetermined torque value during operation, avoiding damage.

To achieve these and other objects of the present invention, a hand tool comprises a tool shaft and a tool head. The tool shaft comprises a shank and a handle pivotally coupled together. The tool head comprises a socket defining a socket hole attachable to a locknut at a coaxial cable for fastening or loosening the locknut and a side opening for the passing of the locknut into or out of the socket hole, a driven structure located on an inner side of a receiving hole at one side of the socket hole, a transmission shaft coupled to the shank of the tool shaft and having a driving head located on one end thereof for engagement with the driven structure of the socket, and an elastic member stopped between the driving head and the socket such that when the socket reaches a predetermined torque value during operation, the driving head is moved axially away from the driven structure to compress the elastic member and to run idle.

Further, the driving head of the transmission shaft comprises a plurality of tooth block for engagement with respective stop blocks of the driven structure. Each stop block of the driven structure comprises opposing push face and vertical stop face. Each tooth block of the driving head comprises opposing sloping face and vertical face. Further, the vertical faces of the tooth blocks of the driving head are forced against the vertical stop faces of the stop blocks of the driven structure to rotate the socket when the transmission shaft is driven by the tool shaft. Further, the sloping faces of the tooth blocks of the driving head are moved along the push faces of the stop blocks of the driven structure in direction away from the driven structure when the socket reaches the predetermined torque value during rotation.

Further, the socket, the transmission shaft and the compression spring are detachable, facilitating replacement of a different design of socket or a compression spring having a different coefficient of elasticity to fit different application requirements.

### BRIEF DESCRIPTION OF THE DRAWINGS

FIG. 1 is an elevational view of a hand tool in accordance with a first embodiment of the present invention.

FIG. 2 is an exploded view of the hand tool in accordance with the first embodiment of the present invention

FIG. 3 corresponds to FIG. 2 when viewed from another angle.

FIG. 4 is a sectional elevation of a part of the hand tool in accordance with the first embodiment of the present invention.

FIG. 5 is a schematic applied view of the first embodiment of the present invention, illustrating an operation status of the hand tool.

FIG. 6 is a sectional view, in an enlarged scale, of a part of FIG. 5.

FIG. 7 is a schematic sectional view of the first embodiment of the present invention, illustrating another application example of the hand tool.

FIG. 8 is an elevational view of a hand tool in accordance with a second embodiment of the present invention.

FIG. 9 is an elevational view of a hand tool according to the prior art.

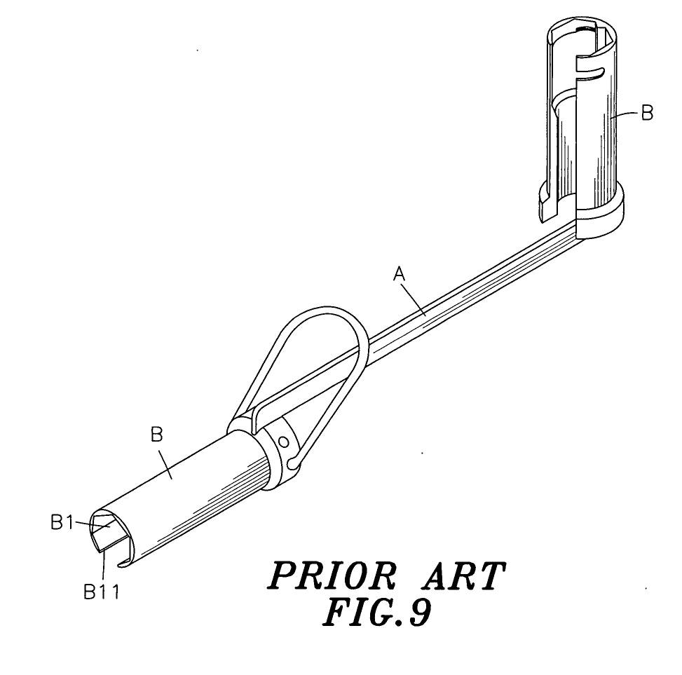

### DETAILED DESCRIPTION OF THE PREFERRED EMBODIMENT

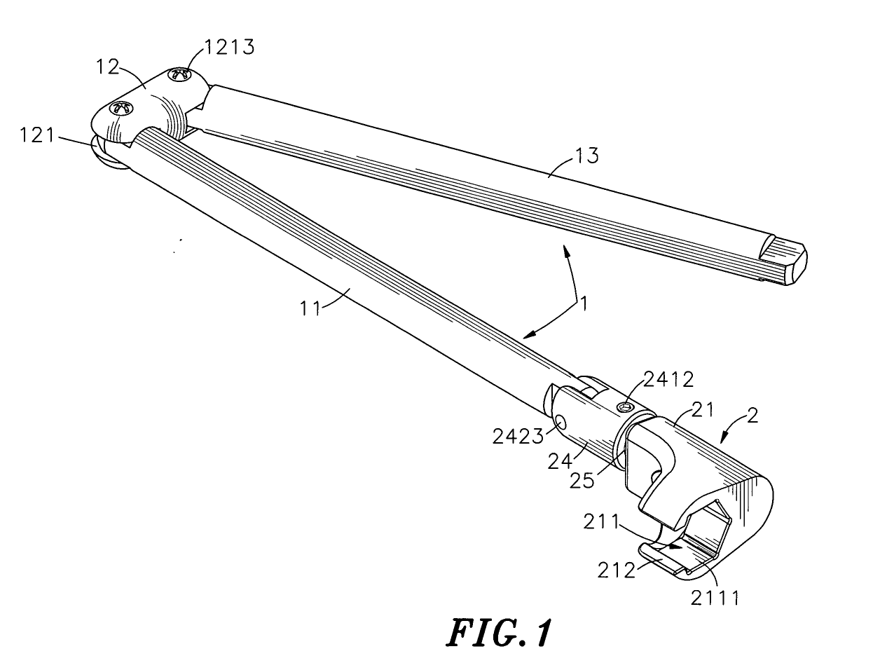

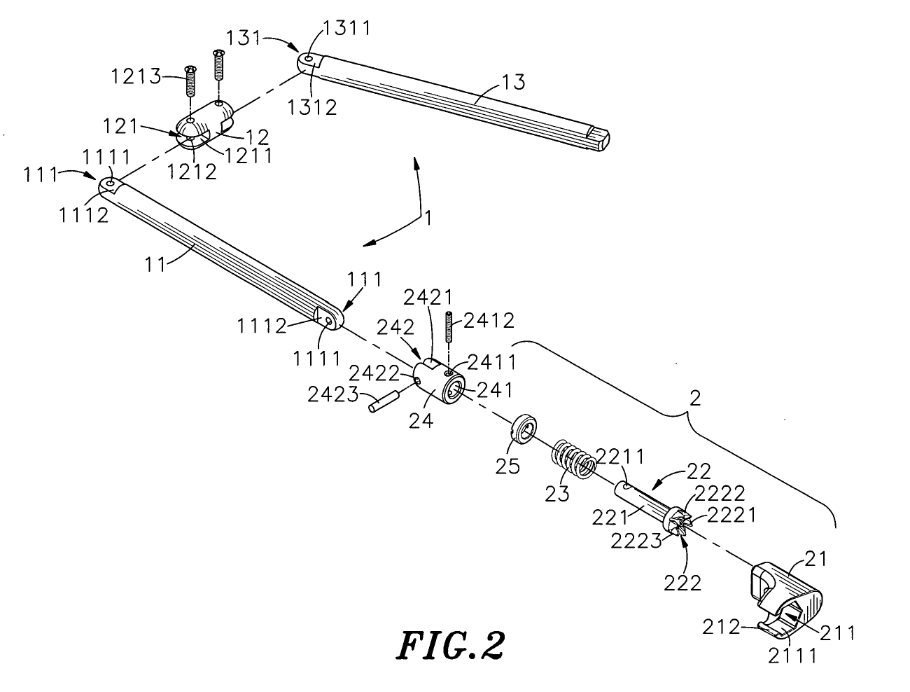

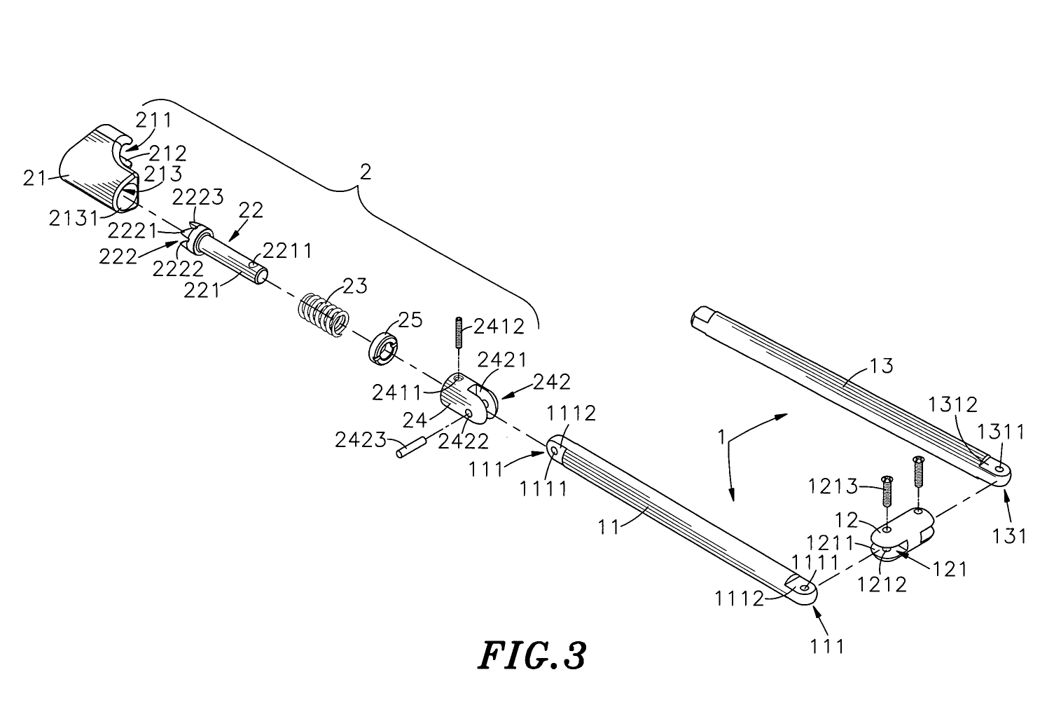

Referring to FIGS. 1-5, a hand tool in accordance with a first embodiment of the present invention is shown comprising a tool shaft 1 and a tool head 2.

The tool shaft 1 comprises a shank 11, a handle 13, a coupling block 12 coupled between the shank 11 and the handle 13, and two pivot screws 1213.

The shank 11 comprises two coupling end portions 111 respectively located on the two distal ends thereof. Each coupling end portion 111 comprises two opposing cut planes 1112 and a pivot hole 1111 cut through the opposing cut planes 1112. The pivot holes 1111 of the two coupling end portions 111 extend in different directions, for example, at right angles.

The handle 13 comprises a coupling end portion 131 located on one end thereof. The coupling end portion 131 comprises two opposing cut planes 1312 and a pivot hole 1311 cut through the opposing cut planes 1312.

The coupling block 12 comprises two flat coupling notches 121 symmetrically disposed at two opposite sides, two pairs of opposing flat inside walls 1211 respectively disposed at two opposite sides relative to the two flat coupling notches 121, and two screw holes 1212 respectively extending through the two pairs of opposing flat inside walls 1211.

The two pivot screws 1213 are respectively threaded into the screw holes 1212 of the coupling block 12 and inserted through the pivot hole 1111 of one coupling end portion 111 of the shank 11 and the pivot hole 1311 of the coupling end portion 131 of the handle 13 to pivotally connect the shank 11 and the handle 13 together, keeping the opposing cut planes 1112 of the respective coupling end portion 111 of the shank 11 and the opposing cut planes 1312 of the coupling end portion 131 of the handle 13 in close contact with the respective flat inside walls 1211 of the coupling block 12.

The tool head 2 is coupled to the other coupling end portion 111 of the shank 11 of the tool shaft 1, comprising a socket 21, a transmission shaft 22, an elastic member, for example, a compression spring 23, and a connection member 24.

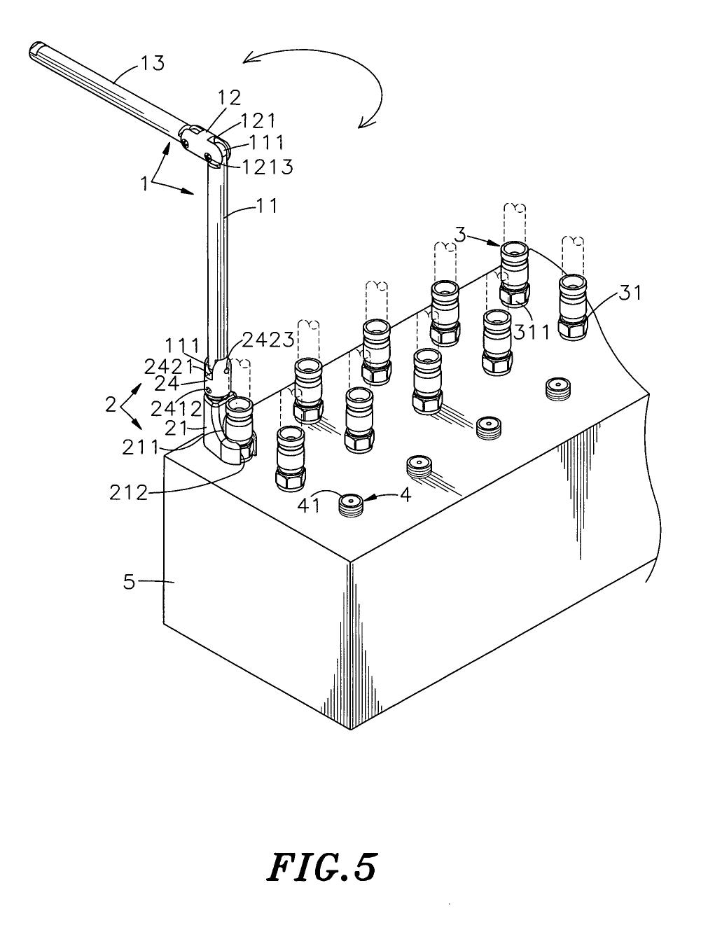

The socket 21 comprises a socket hole 211 extending axially forwards and having at least one pair of opposing bearing faces 2111 defined therein and attachable to a locknut 31 at a coaxial cable 3 for fastening or loosening the locknut 31 (see FIG. 5), a side opening 212 located on one lateral side of the socket hole 211 in communication with the outside space, a receiving hole 213 disposed at an opposite lateral side relative to the socket hole 211, and a driven structure 214 located on the inner side of the receiving hole 213 opposite to the front opening 2131 side of the receiving hole 213. The driven structure 214 consists of a plurality of stop blocks 2141. Each stop block 2141 has a opposing push face 2142 and a vertical stop face 2143.

The transmission shaft 22 is accommodated in the receiving hole 213 of the socket 21, comprising a shaft body 221, a coupling hole 2211 transversely disposed at one end of the shaft body 221, and a driving head 222 located on the other end of the shaft body 221 for engagement with the driven structure 214 of the socket 21. The driving head 222 comprises a plurality of tooth blocks 2221 equiangularly arranged at one side thereof opposite to the shaft body 221. Each tooth block 2221 has a opposing sloping face 2222 and a vertical face 2223.

The compression spring 23 is sleeved onto the shaft body 221 of the transmission shaft 22 and stopped at the driving head 222.

The connection member 24 has an insertion hole 241 axially extended through one end thereof for receiving one end of the shaft body 221 of the transmission shaft 22, a mounting screw hole 2411 transversely extending across the insertion hole 241, a screw rod 2412 threaded into the mounting screw hole 2411 and inserted through the coupling hole 2211 of the shaft body 221 of the transmission shaft 22 to connect the connection member 24 to the transmission shaft 22, a flat coupling notch 242 disposed at the opposite end thereof, two opposing flat inside walls 2421 respectively disposed at two opposite sides relative to the flat coupling notch 242, a pin hole 2422 extending through two opposing flat inside walls 2421, and a pin 2423 press-fitted into the pin hole 2422 and inserted through the pivot hole 1111 of the other coupling end portion 111 of the shank 11 to pivotally connect the shank 11 of the tool shaft 1 to the connection member 24.

Further, the diameter of the coupling hole 2211 of the shaft body 221 of the transmission shaft 22 is greater than the maximum outer diameter of the screw rod 2412 so that the transmission shaft 22 is slightly movable relative to the connection member 24 within a limited range.

The hand tool further comprises a axle bushing 25 mounted in the front opening 2131 of the receiving hole 213 of the socket 21 and sleeved onto the shaft body 221 of the transmission shaft 22 and stopped at one end of the compression spring 23 against the driving head 222 of the transmission shaft 22. However, the axle bushing 25 is not a requisite member. Alternatively, the compression spring 23 can be mounted around the shaft body 221 of the transmission shaft 22 and stopped between the driving head 222 of the transmission shaft 22 and the connection member 24.

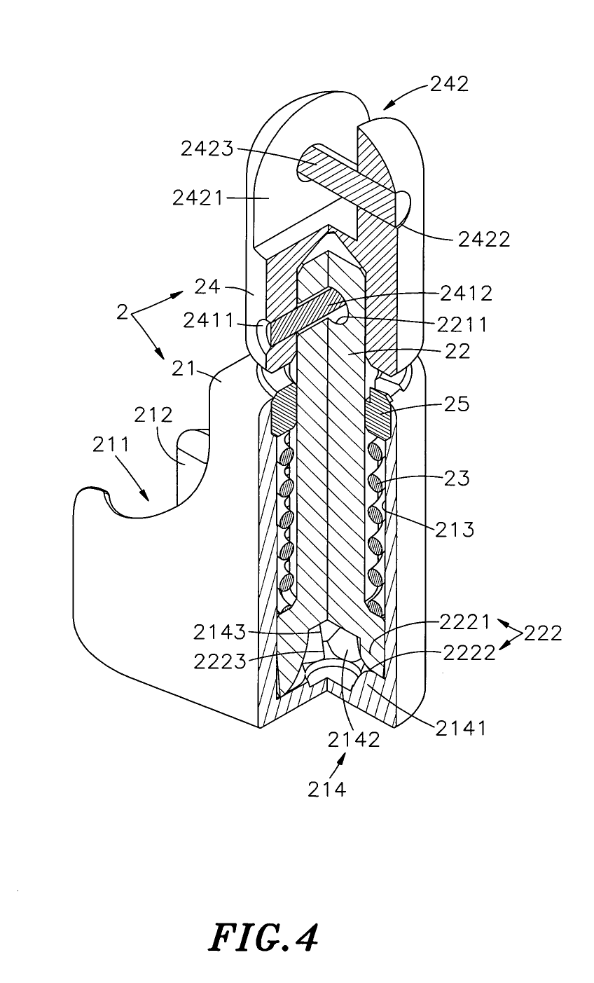

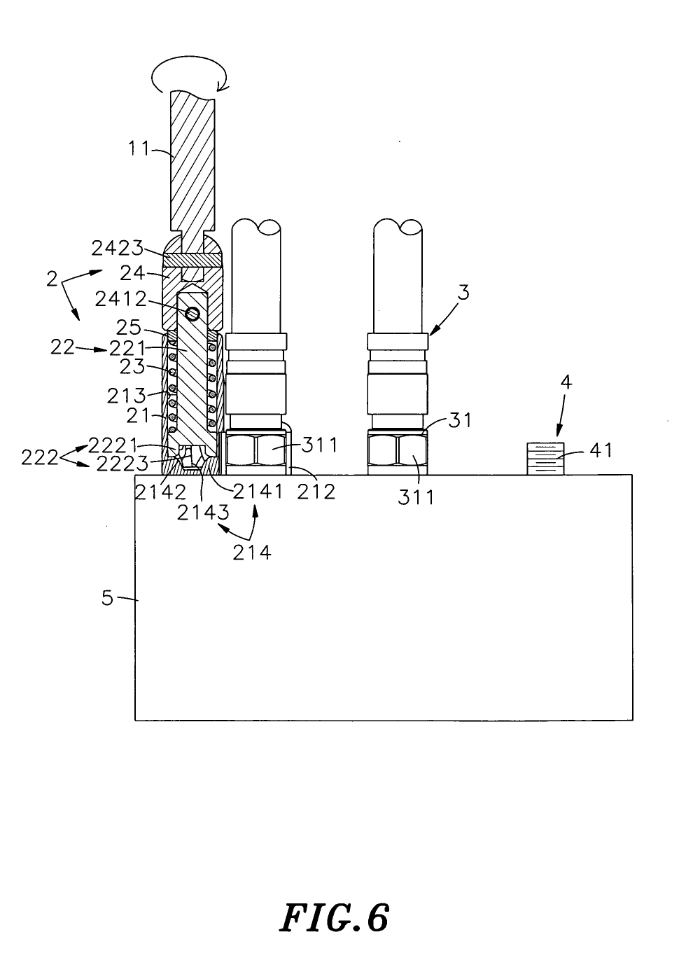

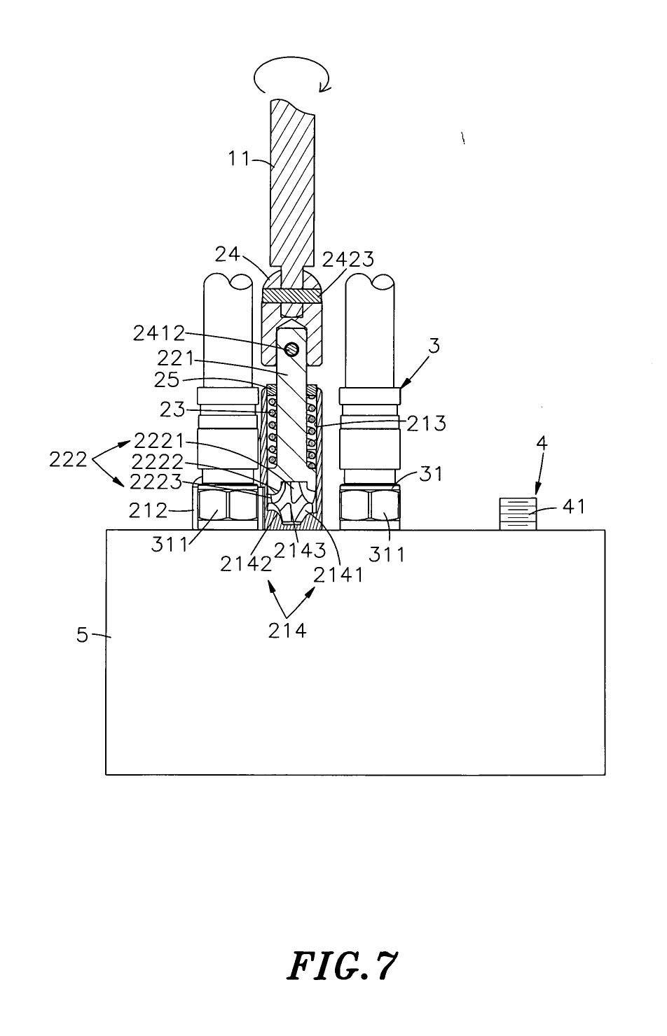

Referring to FIGS. 4-8, the hand tool of the invention is practical for use in a cable TV system for fastening a coaxial cable 3 to one connection screw rod 41 of an electrical connector 4 at an electronic device 5, such as signal distributor or adapter. During installation, insert the center conductor (not shown) of the coaxial cable 3 into the center contact hole at the center of the connection screw rod 41 of the electrical connector 4 and thread the locknut 31 at the coaxial cable 3 onto the connection screw rod 41 of the electrical connector 4 by labor, and then attach the socket 21 of the hand tool to the locknut 31 and operate the hand tool to fasten tight the locknut 31. By means of the side opening 212 of the socket 21, the locknut 31 can be conveniently inserted into the socket hole 211 to have a hexagonal periphery 311 of the locknut 31 be abutted against the opposing bearing faces 2111 of the socket 21. At this time, the user can hold the handle 13 at about 90-degrees angle relative to the shank 11 and then operate the handle 13 to rotate the shank 11 and the tool head 2, thereby fastening up the locknut 31. Subject to the coupling arrangement of the coupling block 12 between the shank 11 and the handle 13 and the coupling arrangement between the connection member 24 of the tool head 2 and the shank 11 of the tool shaft 1, the handle 13 can be adjusted to any desired angle relative to the socket 21 to fit different installation conditions, facilitating application in a narrow space.

During application of the hand tool, the compression spring 23 imparts a pressure to the driving head 222 of the transmission shaft 22 in direction away from the axle bushing 25 (or the connection member 24), forcing the tooth blocks 2221 of the driving head 222 into positive engagement with the stop blocks 2141 of the driven structure 214, and therefore the socket 21 can be positively driven by the tool shaft 1 to rotate the locknut 31 of the coaxial cable 3 relative to the connection screw rod 41 of the electrical connector 4 of the electronic device 5 to further fasten tight or loosen the locknut 31.

When the socket 21 reaches a predetermined torque value during operation of the tool shaft 2 to rotate the transmission shaft 22 of the tool head 2, the opposing sloping faces 2222 of the tooth blocks 2221 of the driving head 222 of the transmission shaft 22 are respectively abutted against the push faces 2142 of the respective stop blocks 2141 of the driven structured 214 of the socket 21. When continuously rotating the socket 21 at this time, subject to the design that the diameter of the coupling hole 2211 of the shaft body 221 of the transmission shaft 22 is greater than the maximum outer diameter of the screw rod 2412 for enabling the transmission shaft 22 to be slightly movable relative to the connection member 24 within a limited range, the tooth blocks 2221 of the driving head 222 will be moved over the stop blocks 2141 of the driven structured 214 of the socket 21 to run idle, avoiding damage and enhancing durability of the hand tool.

When the user wishes to loosen the locknut 31 of the coaxial cable 3 from the connection screw rod 41 of the electrical connector 4 of the electronic device 5, attach the socket 21 of the tool head 2 to the locknut 31 and then turn the handle 13 of the tool shaft 1 in the reversed direction to abut the vertical faces 2223 of the tooth blocks 2221 of the transmission shaft 22 of the tool head 2 against the vertical stop faces 2143 of the stop blocks 2141 of the driven structured 214 of the socket 21 and to further rotate the socket 21 and the locknut 31 relative to the connection screw rod 41 of the electrical connector 4. When loosening the locknut 31, the opposing bearing walls 2111 in the socket hole 211 of the socket 21 are respectively abutted against the hexagonal periphery 311 of the locknut 31, enabling the locknut 31 to be rotated by the socket 21 positively without causing damage. Further, the socket 21, the transmission shaft 22 and the compression spring 23 are detachable, facilitating replacement of a different design of socket or a compression spring having a different coefficient of elasticity to fit different application requirements.

Thus, when the user is going to loosen the locknut 31 of the coaxial cable 3, the user simply needs to rotate the handle 13 of the tool shaft 1 in the reversed direction. Subject to abutment between the vertical faces 2223 of the tooth blocks 2221 of the transmission shaft 22 of the tool head 2 and the vertical stop faces 2143 of the stop blocks 2141 of the driven structured 214 of the socket 21 and abutment between the opposing bearing walls 2111 of the socket 21 and the hexagonal periphery 311 of the locknut 31 of the coaxial cable 3, the socket 21 is driven by the transmission shaft 22 to rotate the locknut 31 of the coaxial cable 3 positively, avoiding damage. Even if the locknut 31 starts to wear, the socket 21 can still positively rotate the locknut 31.

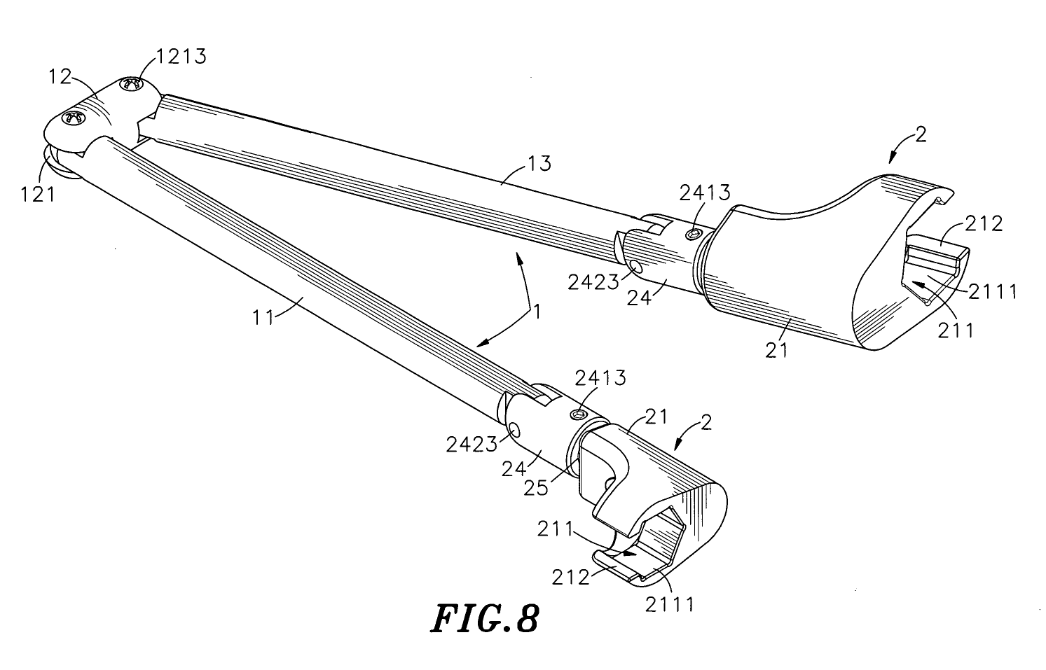

FIG. 8 illustrates a hand tool in accordance with a second embodiment of the present invention. According to this second embodiment, the hand tool comprises the tool shaft 1 and two tool heads 2. The two tool heads 2 are respectively coupled to the distal end of the shank 11 and the distal end of the handle 13. Similar to the aforesaid first embodiment of the present invention, the tool head 2 of this second embodiment comprises the socket 21, the transmission shaft 22, an elastic member, for example, the compression spring 23, and the connection member 24. The structural features of the socket 21, the transmission shaft 22, the compression spring 23 and the connection member 24 of each tool head 2 are same as the aforesaid first embodiment of the present invention. Further, the sockets 21 of the two tool heads 2 can be prepared subject to two different specifications or different patterns for rotating different locknuts.

Although particular embodiments of the invention have been described in detail for purposes of illustration, various modifications and enhancements may be made without departing from the spirit and scope of the invention. Accordingly, the invention is not to be limited except as by the appended claims.

What the invention claimed is:

1. A hand tool, comprising:
a tool shaft comprising at least one shank, said at least one shank comprising a first coupling end portion located on one end thereof; and
a tool head coupled to the first coupling end portion of said at least one shank of said tool shaft, said tool head comprising a socket, a transmission shaft and an elastic member, said socket comprising a socket hole extending axially forwards and attachable to a locknut at a coaxial cable for fastening or loosening said locknut, a side opening located on one lateral side of said socket hole for the passing of said locknut into or out of said socket hole, a receiving hole disposed at an opposite lateral side relative to said socket hole, and a driven structure located on an inner side of said receiving hole, said transmission shaft being accommodated in said receiving hole of said socket, said transmission shaft comprising a shaft body and a driving head located on an opposite end of said shaft body for engagement with said driven structure of said socket, said elastic member being sleeved onto said shaft body of said transmission shaft and stopped between said driving head and said socket such that when said tool shaft is operated by an external force to rotate forward said transmission shaft and said socket forwardly to reach a predetermined torque value, said driving head is moved axially away from said driven structure to compress said elastic member and to run idle.

2. The hand tool as claimed in claim 1, wherein said at least one shank further comprises a second coupling end portion located on an opposite end thereof, said first coupling end portion and said second coupling end portion each comprising two opposing cut planes and a pivot hole cut through the cut planes, the pivot hole of said first coupling end portion and the pivot hole of said second coupling end portion extending in different directions and being respectively pivotally connected to said tool head and a handle; said tool shaft further comprises a handle and a coupling block coupled between said second coupling end portion of said at least one shank and said handle.

3. The hand tool as claimed in claim 2, wherein said coupling block comprises two flat coupling notches symmetrically disposed at two opposite sides, two pairs of opposing flat inside walls respectively disposed at two opposite sides relative to said two flat coupling notches and two screw holes respectively extending through said two pairs of opposing flat inside walls; said handle comprises a coupling end portion located on one end thereof and inserted into one flat coupling notch of said coupling block, the coupling end portion of said handle comprising two opposing cut planes respectively kept in contact with the opposing flat inside walls of one flat coupling notch of said coupling block and a pivot hole cut through the cut planes thereof and pivotally connected to the pivot hole in the associating flat coupling notch of said coupling block by a pivot screw; said first coupling end portion of said at least one shank is inserted into the other flat coupling notch of said coupling block, comprising two opposing cut planes respectively kept in contact with the opposing flat inside walls of the associating flat coupling notch of said coupling block and a pivot hole cut through the cut planes thereof and pivotally connected to the pivot hole in the associating flat coupling notch of said coupling block by a respective pivot screw.

4. The hand tool as claimed in claim 1, wherein said socket comprises at least one pair of opposing bearing faces defined in said socket hole and fitting a hexagonal periphery of said locknut.

5. The hand tool as claimed in claim 1, wherein said driven structure consists of a plurality of stop blocks; said driving head comprises a plurality of tooth blocks equiangularly arranged at one side thereof opposite to said shaft body for engagement with said driven structure of said tool head.

6. The hand tool as claimed in claim 5, wherein each said stop block of said driven structure comprises opposing push face and vertical stop face; each said tooth block of said driving head comprises opposing sloping face and vertical face, the sloping faces of the tooth blocks of said driving head are moved along the push faces of the stop blocks of said driven structure in direction away from said driven structure when said socket reaches said predetermined torque value during rotation.

7. The hand tool as claimed in claim 6, wherein the vertical faces of the tooth blocks of said driving head are forced against the vertical stop faces of the stop blocks of said driven structure to rotate said socket when said transmission shaft is driven by said tool shaft.

8. The hand tool as claimed in claim 1, wherein said tool head further comprises a bushing mounted in a front side of said receiving hole of said socket and sleeved onto said shaft body of said transmission shaft and stopped at one end of said elastic member against said driving head of said transmission shaft.

9. The hand tool as claimed in claim 1, wherein said tool head further comprises a connection member coupled between said first coupling end portion of said tool shaft; said elastic member is stopped between said driving head of said transmission shaft and said connection member.

10. The hand tool as claimed in claim 9, wherein said shaft body of said transmission shaft comprises a coupling hole transversely located near one end thereof remote from said driving head; said connection member comprises an insertion hole axially extended through one end thereof for receiving one end of said shaft body of said transmission shaft, a mounting screw hole transversely extending across said insertion hole, a screw rod threaded into said mounting screw hole and inserted through the coupling hole of said shaft body of said transmission shaft to connect said connection member to said transmission shaft, a flat coupling notch disposed at and opposite end thereof for receiving said first coupling end portion of said at least one shank of said tool shaft, two opposing flat inside walls respectively disposed at two opposite sides relative to the flat coupling notch, a pin hole extending through the two opposing flat inside walls, and a pin press-fitted into said pin hole and inserted through the pivot hole of said first coupling end portion of said at least one hank to pivotally connect said at least one shank of said tool shaft to said connection member.
